(19) United States
(12) Patent Application Publication
(10) Pub. No.: US 2025/0247709 A1
(43) Pub. Date: Jul. 31, 2025

(54) INTERCEPTION METHODS AND APPARATUS, AND RELATED DEVICE

(71) Applicant: VIVO MOBILE COMMUNICATION CO., LTD., Dongguan (CN)

(72) Inventors: Yannan YUAN, Dongguan (CN); Fei QIN, Dongguan (CN)

(21) Appl. No.: 19/182,782

(22) Filed: Apr. 18, 2025

Related U.S. Application Data
(63) Continuation of application No. PCT/CN2023/124470, filed on Oct. 13, 2023.

(30) Foreign Application Priority Data
Oct. 20, 2022 (CN) 202211289682.3

(51) Int. Cl. H04W 12/80; H04W 8/22; H04W 64/00

(52) U.S. Cl. CPC H04W 12/80; H04W 8/22; H04W 64/00

(57) ABSTRACT

An interception method includes: obtaining, by a first node, interception information, where the interception information is used to indicate to intercept sensing of a target of interception; and sending, by the first node, a sensing interception product of the target of interception to a lawful interception node based on the interception information.

### CROSS-REFERENCE TO RELATED APPLICATIONS

This application is a bypass continuation application of International Application No. PCT/CN2023/124470, filed on Oct. 13, 2023, which claims the benefit of and priority to Chinese Patent Application No. 202211289682.3, filed on Oct. 20, 2022. The foregoing applications are incorporated herein by reference in their entireties.

### TECHNICAL FIELD

This application relates to the field of communication technologies and, more specifically, relates to an interception method and apparatus and a related device.

### BACKGROUND

With the advancement of mobile communication technologies, future mobile communication systems, such as beyond 5th-generation (B5G) or 6th generation (6G) communication systems, will feature sensing capabilities in addition to communication capabilities. Specifically, by transmitting and receiving sensing signals, these systems will be able to sense information, such as the orientation, distance, and speed of a target object, as well as detect, track, identify, and image a target object, event, environment, or the like.

### BRIEF SUMMARY

Embodiments of this application provide an interception method and apparatus and a related device.

According to a first aspect, an interception method is provided. The method includes:
obtaining, by a first node, interception information, where the interception information is used to indicate to intercept sensing of a target of interception; and
sending, by the first node, a sensing interception product of the target of interception to a lawful interception node based on the interception information.

According to a second aspect, an interception apparatus is provided and applied to a first node. The apparatus includes:
an obtaining module, configured to obtain interception information, where the interception information is used to indicate to intercept sensing of a target of interception; and
a first sending module, configured to send a sensing interception product of the target of interception to a lawful interception node based on the interception information.

According to a third aspect, an interception method is provided. The method includes:
sending, by a lawful interception node, interception information, where the interception information is used to indicate to intercept sensing of a target of interception; and
receiving, by the lawful interception node, a sensing interception product of the target of interception from a first node.

According to a fourth aspect, an interception apparatus is provided, and is applied to a lawful interception node. The apparatus includes:
a second sending module, configured to send interception information, where the interception information is used to indicate to intercept sensing of a target of interception; and
a first receiving module, configured to receive a sensing interception product of the target of interception from a first node.

According to a fifth aspect, a first node is provided. The first node includes a processor and a memory. The memory stores a program or instructions capable of being run on the processor, and when the program or the instructions are executed by the processor, the steps of the method according to the first aspect are implemented.

According to a sixth aspect, a first node is provided, including a processor and a communication interface. The communication interface is configured to: obtain interception information, where the interception information is used to indicate to intercept sensing of a target of interception; and send a sensing interception product of the target of interception to a lawful interception node based on the interception information.

According to a seventh aspect, a lawful interception node is provided. The lawful interception node includes a processor and a memory. The memory stores a program or instructions capable of being run on the processor, and when the program or the instructions are executed by the processor, the steps of the method according to the third aspect are implemented.

According to an eighth aspect, a lawful interception node is provided, including a processor and a communication interface. The communication interface is configured to: send interception information, where the interception information is used to indicate to intercept sensing of a target of interception; and receive a sensing interception product of the target of interception from a first node.

According to a ninth aspect, a lawful interception system is provided, including a first node and a lawful interception node. The first node may be configured to perform the steps of the interception method according to the first aspect, and the lawful interception node may be configured to perform the steps of the interception method according to the third aspect.

According to a tenth aspect, a readable storage medium is provided. The readable storage medium stores a program or instructions, and when the program or the instructions are executed by a processor, the steps of the method according to the first aspect are implemented, or the steps of the method according to the third aspect are implemented.

According to an eleventh aspect, a chip is provided. The chip includes a processor and a communication interface, and the communication interface is coupled to the processor. The processor is configured to run a program or instructions to implement the steps of the method according to the first aspect or the steps of the method according to the third aspect.

According to a twelfth aspect, a computer program/program product is provided. The computer program/program product is stored in a storage medium. The computer program/program product is executed by at least one processor to implement the steps of the method according to the first aspect or the steps of the method according to the third aspect.

In embodiments of this application, a first node obtains interception information, where the interception information is used to indicate to intercept sensing of a target of interception; and the first node sends a sensing interception product of the target of interception to a lawful interception node based on the interception information. In this way, the lawful interception node can intercept sensing of the target of interception.

### BRIEF DESCRIPTION OF DRAWINGS

FIG. 1 is a block diagram of a wireless communication system applicable to an embodiment of this application;

FIG. 2 is a schematic diagram of six sensing manners according to an embodiment of this application;

FIG. 3 is a schematic diagram of a lawful interception architecture according to an embodiment of this application;

FIG. 4 is a flowchart of an interception method according to an embodiment of this application;

FIG. 5 is a flowchart of another interception method according to an embodiment of this application;

FIG. 6 is a structural diagram of an interception apparatus according to an embodiment of this application;

FIG. 7 is a structural diagram of another interception apparatus according to an embodiment of this application;

FIG. 8 is a structural diagram of a communication device according to an embodiment of this application;

FIG. 9 is a structural diagram of a first node according to an embodiment of this application; and

FIG. 10 is a structural diagram of a lawful interception node according to an embodiment of this application.

### DESCRIPTION OF EMBODIMENTS

The following clearly describes technical solutions in embodiments of this application with reference to accompanying drawings in the embodiments of this application. Clearly, the described embodiments are merely some rather than all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specified order or sequence. It should be understood that, terms used in this way may be interchangeable under appropriate circumstances, so that the embodiments of this application can be implemented in an order other than that illustrated or described herein. Moreover, the terms “first” and “second” typically distinguish between objects of one category rather than limiting a quantity of objects. For example, a first object may be one object or a plurality of objects. In addition, in the specification and claims, “and/or” represents at least one of connected objects, and the character “/” generally represents an “or” relationship between associated objects.

It should be noted that, a technology described in the embodiments of this application is not limited to a long term evolution (LTE)/LTE-advanced (LTE-A) system, and may be further applied to other wireless communication systems, such as a code division multiple access (CDMA) system, a time division multiple access (TDMA) system, a frequency division multiple access (FDMA) system, an orthogonal frequency division multiple access (OFDMA) system, a single-carrier frequency division multiple access (SC-FDMA) system, and another system. The terms “system” and “network” are often used interchangeably in the embodiments of this application. A technology described may be used for the systems and radio technologies described above, as well as other systems and radio technologies. A new radio (NR) system is described in the following descriptions for illustrative purposes, and NR terms are used in most of the following descriptions. However, these technologies can also be applied to applications such as a 6th generation (6G) communication system other than NR system applications.

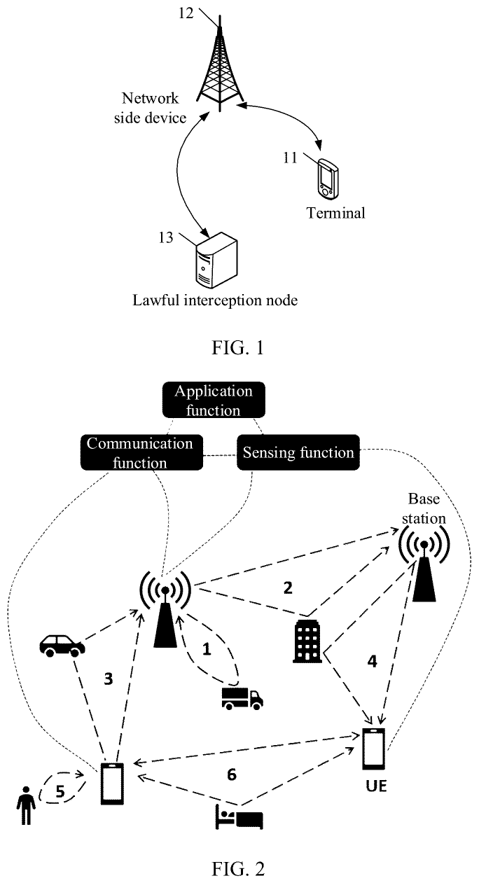

FIG. 1 is a block diagram of a wireless communication system applicable to an embodiment of this application. The wireless communication system includes a terminal 11, a network side device 12, and a lawful interception node 13. The terminal 11 may be a mobile phone, a tablet personal computer, a laptop computer that is alternatively referred to as a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a laundry machine, or a furniture), a gaming console, a personal computer (PC), a teller machine, a self-service machine, or another terminal side device. The wearable device includes: a smart watch, a smart band, a smart headset, smart glasses, smart jewelry (a smart bracelet, a smart wristlet, a smart ring, a smart necklace, a smart anklet, a smart leglet, and the like), a smart wristband, smart clothing, and the like. It should be noted that a specific type of the terminal 11 is not limited in this embodiment of this application. The network side device 12 may include an access network device or a core network device. The access network device may also be referred to as a wireless access network device, a radio access network (RAN), a radio access network function, or a radio access network unit. The access network device may include a base station, a wireless local area network (WLAN) access point, a WiFi node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another appropriate term in the field. Provided that same technical effects are achieved, the base station is not limited to a specific technical term. It should be noted that in the embodiments of this application, only a base station in an NR system is used as an example for description, and a specific type of the base station is not limited. The core network device may include but is not limited to at least one of the following: a core network node, a core network function, a mobility management entity (MME), an access and mobility management function (AMF), a session management function (SMF), a user plane function (UPF), a policy control function (PCF), a policy and charging rules function (PCRF) unit, an edge application server discovery function (EASDF), unified data management (UDM), unified data repository (UDR), a home subscriber server (HSS), a centralized network configuration (CNC), a network repository function (NRF), a network exposure function (NEF), a local NEF (or L-NEF), a binding support function (BSF), an application function (AF), and the like. It should be noted that in the embodiments of this application, only a core network device in the NR system is used as an example for description, and a specific type of the core network device is not limited. The lawful interception node 13 may include but is not limited to a law enforcement agency (LEA), a law enforcement monitoring facility (LEMF), a third-party lawful interception agency, and the like. The third-party lawful interception agency may be understood as a third-party agency other than a sensing service provider and a sensing service user, and may be used to supervise a sensing service.

For ease of understanding, the following describes some content related to the embodiments of this application.

### I. Integrated Communication and Sensing

Integrated communication and sensing means that in a same system, a design of integrated communication and sensing functions is implemented through spectrum sharing and hardware sharing. When transferring information, the system can sense information such as an orientation, a distance, and a speed, and detect, track, and identify a target device or an event. A communication system and a sensing system cooperate with each other, to improve overall performance and bring better service experience.

A future mobile communication system, such as a beyond 5-generation (B5G) mobile communication system or a 6G mobile communication system, has a sensing capability in addition to a communication capability. The sensing capability means that, by sending and receiving a wireless signal, one or more devices with the sensing capability can sense information such as an orientation, a distance, and a speed of a target object, or detect, track, identify, and image a target object, an event, an environment, or the like. In the future, with the deployment of a small base station with a capability of a high frequency band and large bandwidth such as a millimeter wave and terahertz in a 6G network, resolution of sensing is significantly improved when compared with that of a centimeter wave, so that the 6G network can provide a more refined sensing service. Typical sensing functions and application scenarios are shown in Table 1.

Expressions of quality of service requirements for the foregoing sensing services are different. For example, a quality of service requirement for sensing such as intelligent traffic or a high-precision map is usually expressed by using a sensing distance, range resolution, angle resolution, velocity resolution, and a sensing latency; a quality of service requirement for flight intrusion detection sensing is usually expressed by using coverage height, sensing accuracy, and a sensing latency; a quality of service requirement for respiration monitoring is expressed by using a sensing distance, a sensing real-time characteristic, sensing resolution, and sensing accuracy; a quality of service requirement for indoor intrusion detection is expressed by using a sensing distance, a sensing real-time characteristic, a detection probability, and a false alarm probability; and a quality of service requirement for gesture/posture recognition is expressed by using a sensing distance, a sensing real-time characteristic, and sensing accuracy.

Service requesting manners for the foregoing sensing services are different. For example, for a service request based on a static area, a specific coordinate system is used to represent a geographic location area of content to be sensed; for a service request based on a dynamic area, M meters around specific UE are used to represent a geographic location range of content to be sensed, where M is a positive number; and for a continuous sensing service request for a specific dynamic target, a target tracked based on a specific detected and continuous location is used to represent a sensing target whose content needs to be sensed.

TABLE 1

| Communication | | |
|---|---|---|
| sensing category | Sensing function | Application scenario |
| Macro sensing | Weather condition, air quality, and the | Meteorology, agriculture, and |
| type | like | life services |
| | Traffic flow (intersections) and crowd | Intelligent traffic and |
| | flow (subway entrances) | commercial services |
| | Target tracking, distance measurement, | Many application scenarios of a |
| | speed measurement, outlining, and the | conventional radar |
| | like | |
| | Environment reconstruction | Intelligent driving and |
| | | navigation |
| | | (automobiles/unmanned aerial |
| | | vehicles), smart city (3D maps), |
| | | and network planning and |
| | | network optimization |
| Granular sensing | Action/posture/expression recognition | Smart interaction of |
| type | | smartphones, gaming, and smart |
| | | home |
| | Heartbeat/breathing and the like | Health and medical care |
| | Imaging, material detection, | Security inspection, industry, |
| | component analysis, and the like | biological medicine, and the like |

II. Sensing Manner Obtained Through Division from a Radio Link

As shown in FIG. 2, based on different sensing signal sending and receiving manners, there are mainly six sensing manners (that is, six sensing manners indicated by 1 to 6 in the figure): self-transmitting and self-receiving by a base station, coordinated sensing between base stations, sending by a terminal and receiving by a base station, sending by a base station and receiving by a terminal, self-transmitting and self-receiving by a terminal, and coordinated sensing between terminals. Generally, a sensing signal receiving node measures a received sensing signal, and reports a measurement result to a target node. The target node is responsible for calculating a sensing result based on a sensing measurement result. For example, the target node may be a sensing function.

### III. Lawful Interception Architecture and Function

In a related technology, lawful interception is mainly directed to an existing service scoping (for example, voice, a data packet, messaging, and target positioning) of a communication service provider, and data of user equipment (UE) to be intercepted is obtained via network layer based interception and service layer based interception. The network layer based interception is to obtain, from a point of interception of a core network network function (for example, an AMF or an SMF/UPF), data to be intercepted, and the service layer based interception is to obtain, from a service function (for example, an IMS or a location service) of the communication service provider, data to be intercepted.

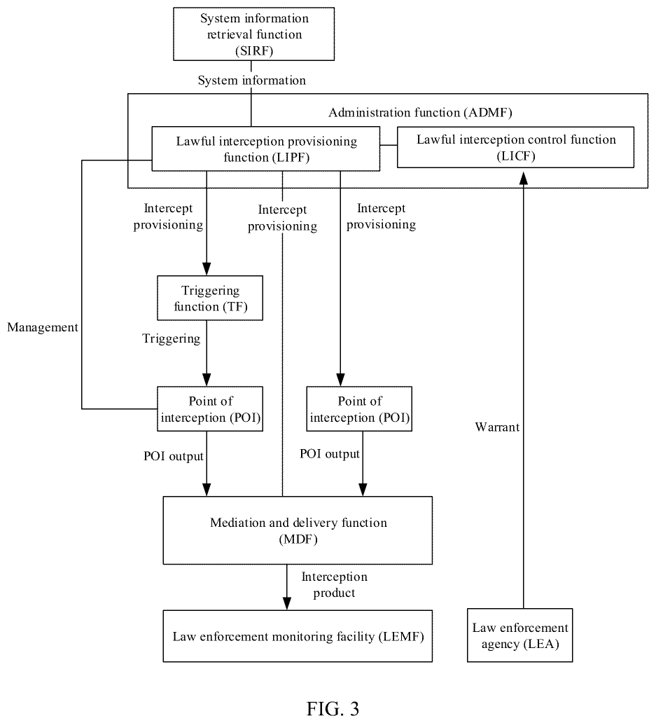

As shown in FIG. 3, a lawful interception architecture and function in the related technology may be used by the communication service provider (Communication Service Provider, CSP) to meet a requirement of lawful interception. This mainly includes: detecting target communication, obtaining intercept related information (IRI) or communication content (CC) from the target communication, and sending the intercept related information or the communication content to a lawful interception device. Based on content to be intercepted, the point of interception (POI) may be located on a required network function and a required service function, for example, an access and mobility management function (AMF), a session management function (SMF)/user plane function (UPF), a UDM, an NRF, an NEF, a short message service function (SMSF), or an IP multimedia subsystem (IMS).

As shown in FIG. 3, a lawful interception node (for example, an LEA) sends a warrant and the following information to the communication service provider, for example, an administration function (ADMF) of the communication service provider. The ADMF may include a lawful interception provisioning function (LIPF) and a lawful interception control function (LICF). The communication service provider provides a lawful interception product by using a corresponding network function (that is, the POI) and transfers the lawful interception product to an LEMF by using a mediation and delivery function (MDF). It can be seen from the following information list that a service scoping intercepted in lawful interception mainly includes voice, a data packet, messaging, and target positioning.
Target identifier: used to identify the communications to be intercepted.
Type of intercept: used to indicate whether IRI only, CC only, or both IRI and CC, is to be delivered to a law enforcement monitoring facility.
Service scoping: used to identify a service (for example, voice, a data packet, messaging, and target positioning) to be intercepted.
Filtering criteria: used to provide additional specificity for the interception, for example, for bandwidth optimization.
LEMF address: used to deliver the interception product.
Lawful interception identifier: used to associate the issued warrant with the interception product.

The target identifier may include a subscription permanent identifier (SUPI), a permanent equipment identifier (PEI), a generic public subscription identifier (GPSI), and the like.

The PEI is used by 3rd Generation Partnership Project (3GPP) UE to access a 5G system. If the UE supports at least one 3GPP access technology (that is, a next generation radio access network (NG-RAN)/5G, an evolved universal terrestrial radio access network (E-UTRAN)/4G, a UTRAN/3G, and a GSM/EDGE radio access network (GERAN)/EDGE/2.5G), an international mobile equipment identity (IMEI) or a PEI in an international mobile equipment identity software version (MEISV) format needs to be allocated to the UE.

The GPSI may be used to deal with 3GPP users in different data networks (DN) outside a 3GPP system. The 3GPP system stores an association between the GPSI and the corresponding SUPI in user data. The GPSI may be a mobile station international subscriber directory number (MSISDN), an external IP address, or the like.

### IV. Positioning Service of a Mobile Communication Network

A positioning service of a current mobile communication network includes three cases: (1) UE positions itself. (2) An application function of an external server/client positions the UE. (3) An internal network element in a network positions the UE. In an intra-network positioning procedure, UE location information is obtained based on uplink or downlink measurement through interaction between a location management function (LMF) and a base station and/or the UE. Based on the foregoing information, it may be found that a positioning service in a related technology is closely related to positioning of target UE, and for positioning of the target UE, the target UE needs to send a signal or perform measurement. Positioning-related interception is, in one aspect, network layer based interception, and positioning messages related to specific target UE that are exchanged between the UE and the LMF and between a gNB and the LMF are obtained from an AMF. Positioning-related interception is, in another aspect, service layer based interception that includes: the UE provides a location report (a mobile network cell ID, geographic coordinates, or the like) when performing a specific network service (for example, voice over NR (Voice over New Radio, VoNR)), and a lawful interception function calls the LMF to obtain location information of the target UE (a key is to override UE privacy). Therefore, positioning interception may include: using, as tag data/auxiliary data of another interception product, positioning measurement data for positioning the target UE and UE location information data that can be provided by a network, and calling, by a lawful interception device in a case that authorization by the UE is not required, a positioning service to obtain location data.

### V. Sensing Quality of Service (QOS)

The sensing QoS includes at least one sensing performance indicator and corresponding information (for example, a value requirement) in Table 2.

TABLE 2
Sensing performance indicators and corresponding information thereof

| Sensing performance | |
|---|---|
| indicator | Definition |
| Sensing accuracy | The sensing accuracy is a degree of deviation between a real result |
| | and a sensing result at a specific confidence level, and may be |
| | represented by a sensing error (for example, a root mean square error). |
| | A smaller sensing error indicates higher sensing accuracy. The sensing |
| | accuracy includes distance accuracy, speed accuracy, angle accuracy, |
| | other sensing accuracy, and the like. |
| Sensing resolution | The sensing resolution is a capability of distinguishing between a |
| | plurality of sensing targets from different dimensions, and includes |
| | range resolution, velocity resolution, angle resolution, and the like. |
| Sensing distance | The sensing distance is a valid range of a specific sensing parameter |
| | while a specific sensing performance indicator (for example, sensing |
| | accuracy) is met, and specifically includes a sensing distance range, a |
| | sensing speed range, a sensing angle range, and the like. |
| Sensing latency | The sensing latency is used to quantitatively describe a real-time |
| | performance requirement of a sensing service, for example, a |
| | maximum delay from generating a sensing service request to feeding |
| | back a sensing result. |
| Sensing update | The sensing update frequency is a reciprocal of a time interval |
| frequency | between two adjacent sensing results. |

### VI. Sensing Measurement Quantity

In an optional classification manner, sensing measurement quantities are classified into the following four types (this description focuses on describing the measurement quantity, and the sensing measurement quantities may alternatively be classified into three types or not classified, and the four types are merely used for illustration). Based on a relationship between a sensing measurement quantity and a sensing service, the following third-level measurement quantity and the following fourth-level measurement quantity may also be referred to as sensing results, and the following second-level measurement quantity and/or the following first-level measurement quantity may also be referred to as sensing measurement data.

The first-level measurement quantity is a received signal/original channel information, and includes a received signal/channel response complex result, an amplitude/phase, an I-channel/Q-channel and operation results thereof (operations include addition, subtraction, multiplication, and division, matrix addition, subtraction, and multiplication, matrix transposition, a trigonometric operation, a square root operation, a power operation, and the like, along with a threshold detection result, a maximum/minimum value extraction result, and the like of results of the foregoing operations; and the operations further include fast Fourier transform (FFT)/inverse fast Fourier transform (IFFT), discrete Fourier transform (DFT)/inverse discrete Fourier transform (IDFT), 2D-FFT, 3D-FFT, matched filtering, an autocorrelation operation, wavelet transform, digital filtering, and the like, along with a threshold detection result, a maximum/minimum value extraction result, and the like of results of the foregoing operations).

The second-level measurement quantity is a basic measurement quantity, and includes delay, Doppler, angle, signal strength, and a multi-dimensional combination of delay, Doppler, angle, signal strength.

The third-level measurement quantity is a basic attribute/state, and includes a distance, a speed, an angle/orientation, a radar cross-section (RCS), an acceleration, and the like.

The fourth-level measurement quantity is an advanced attribute/state, and includes: a spatial location, whether a target exists, a track, an action, an expression, a vital sign, a quantity, an imaging result, weather, air quality, a shape, a material, a component, and the like.

### VII. Sensing Function (SF) Node

The sensing function node may include at least one of the following functions:
receiving a sensing service request, and determining a required sensing measurement quantity based on the sensing service request;
receiving a sensing measurement result (that is, a value of the sensing measurement quantity), where the sensing measurement quantity is a first-level measurement quantity and/or a second-level measurement quantity; generating a sensing result (a third-level measurement quantity); and responding to the sensing service request, where in this application, this function is referred to as a basic sensing function node;
receiving a sensing measurement result of the third-level measurement quantity, generating a sensing result (a fourth-level measurement quantity), and responding to the sensing service request, where in this application, this function is referred to as a derivative sensing function node;
receiving a sensing measurement result (that is, a value of the sensing measurement quantity), where the sensing measurement quantity is a first-level measurement quantity and/or a second-level measurement quantity and/or a third-level measurement quantity; generating a sensing result (a fourth-level measurement quantity); and responding to the sensing service request, where in this application, this function is referred to as a comprehensive sensing function node;
controlling sensing quality of service (QOS), that is, controlling a sensing-related node for a sensing quality of service requirement, to meet the sensing QoS requirement;
determining a sensing signal sending or receiving node or a sensing auxiliary node, where sensing signal sending or receiving nodes in a mobile communication system include a network device (for example, a base station) and user equipment UE (for example, a mobile phone), and the sensing auxiliary node is configured to provide sensing auxiliary information such as sensing information of another sensor, geographic location information, and the like, to improve wireless sensing performance;
determining a sensing link or a sensing manner, where the sensing link may include a Uu link (sending by a base station/receiving by UE or receiving by a base station/sending by UE), a sidelink (sending and receiving between UE), an echo link (self-transmitting and self-receiving by a base station, and self-transmitting and self-receiving by UE), and an inter-base station transceiver link (sending and receiving between base stations), and the sensing manner may include: sending by a base station and receiving by UE, sending by UE and receiving by a base station, self-transmitting and self-receiving by a base station, sending and receiving between UE, sending and receiving between base stations, and self-transmitting and self-receiving by UE;
determining a sensing signal, where potential sensing signals include a reference signal and a data signal, and the reference signal may be a communication reference signal or a sensing-dedicated reference signal;
determining a time-frequency resource used for sensing, where potential sensing resources include a time-frequency resource (for example, a guard band) that is not used in communication, a common time-frequency resource (for example, a reference signal or a data signal) that has been used in communication, and a sensing-dedicated time-frequency resource;
determining a configuration of the sensing signal, where a potential configuration includes time, frequency, and space domain resource information of the sensing signal; if a node that determines the time-frequency resource for sensing is not a sending node of the sensing signal, sending a sensing signal configuration to the sending node of the sensing signal;
determining a configuration of the sensing measurement quantity, where a potential configuration includes a sensing signal indication to be measured, a quantity or time of sensing signals to be measured, a reporting indication of a measurement result, and the like; if a node that determines the configuration of the sensing measurement quantity is not a receiving and measurement node of the sensing signal, sending the configuration of the sensing measurement quantity to the receiving node of the sensing signal;
determining and configuring a transport channel for reporting a sensing measurement result, including establishing, modifying, or releasing the transport channel; and
determining an AMF, where after a network side device determines the sensing function node based on a geographic range of a requested sensing service and a geographic range in which the sensing function node provides the sensing service, the sensing function node needs to determine the AMF in at least one of the following cases: (1) when a sensing target is specific UE in a case that the UE is the sending node of the sensing signal, the receiving node of the sensing signal, or a sensing auxiliary node, the sensing function node selects the AMF based on a geographic area to be sensed and based on a tracking area identity (TAI) of the AMF requested from an NRF and/or an AMF identity (ID)/location and the like; (2) when sensing data needs to be transmitted (for example, defined as a NAS message or a NAS layer as a transport bearer protocol layer for sensing data), the sensing function node selects the AMF based on geographic location information (for example, a TA) of a sensing node of data to be transmitted and based on a TAI of the AMF requested from an NRF, an AMF ID/location, and/or the like; and (3) when the sensing target is 3GPP UE, the sensing function node determines the AMF based on a UE identity (for example, an AMF UE NG application protocol (NGAP) ID) and the like.

With the development of mobile communication technologies, a future mobile communication system, such as a beyond 5th-generation (B5G) communication system or a 6th generation (6G) communication system, has a sensing capability in addition to a communication capability. To be specific, through sending and receiving of a sensing signal, information such as an orientation, a distance, and a speed of a target object can be sensed, or a target object, an event, an environment, or the like can be detected, tracked, identified, and imaged. However, lawful interception in a related technology is mainly directed to an existing service scoping (for example, voice, a data packet, messaging, and target positioning) of a communication service provider, and data of user equipment (UE) to be intercepted is obtained via network layer based interception or service layer based interception. There is no corresponding solution about how to perform lawful interception on a sensing service.

Embodiments of this application provide an interception method and apparatus and a related device, to provide a manner of performing lawful interception on sensing of a target of interception.

An interception method provided in embodiments of this application is described in detail below with reference to the accompanying drawing by using some embodiments and application scenarios thereof.

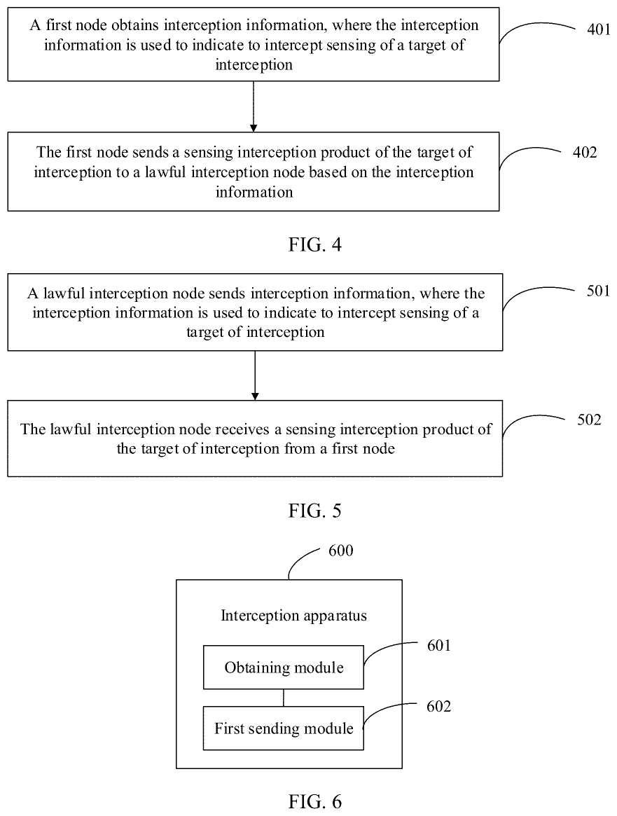

Referring to FIG. 4, FIG. 4 is a flowchart of an interception method according to an embodiment of this application. The method may be performed by a first node. As shown in FIG. 4, the method includes the following steps.

Step 401: The first node obtains interception information, where the interception information is used to indicate to intercept sensing of a target of interception.

In this embodiment, the first node may include a network function node (for example, a POI), a sensing service user, or the like. The network function node may include but is not limited to an SF, an AMF, an NEF, a base station (for example, a gNB), or the like. The sensing service user may include a sending node of a sensing request, a receiving node of sensing data, or the like.

The target of interception may include at least one of a sensing target, a sensing area, the sending node of the sensing request, a receiving node of a sensing result, and the like. The intercepting sensing of the target of interception may be understood as intercepting at least one of sensing-related information and sensing content of the target of interception.

For example, the first node may receive the interception information from a lawful interception node (for example, an LEA or an LEMF), or may obtain the interception information in another manner, for example, receive interception information entered by a user.

Step 402: The first node sends a sensing interception product of the target of interception to the lawful interception node based on the interception information.

The lawful interception node may include but is not limited to an LEA, an LEMF, a third-party lawful interception agency, or the like. The third-party lawful interception agency may be understood as a third-party agency other than a sensing service provider and a sensing service user, and may be used to supervise a sensing service.

The sensing interception product may be understood as an interception product obtained by intercepting sensing of the target of interception. Optionally, the sensing interception product includes at least one of sensing-related information and sensing content. The sensing-related information may include but is not limited to at least one of a sensing request, a sensing configuration, a sensing response, sensing measurement data, a sensing result, a sensing-related information event (for example, location update or sensing handover), and the like, for example, a sensing request, a sensing response, or a sensing report that is of network-based sensing and that is related to the target of interception and exchanged between the SF and an NG-RAN through the AMF, where the network-based sensing includes the following cases: a base station performs self-transmitting and self-receiving, and a sensing signal is sent and received between base stations; and a sensing request, a sensing response, or a sensing report that is of UE-based or UE-assisted sensing and that is related to the target of interception and exchanged between the SF and UE through the AMF, where the UE-based sensing includes the following cases: UE performs self-transmitting and self-receiving, and a sensing signal is sent and received between UE, and the UE-assisted sensing includes: UE sends a sensing signal and a base station receives the sensing signal, and a base station sends a sensing signal and UE receives the sensing signal. The sensing content may include but is not limited to at least one of a sensing request, a sensing response, sensing measurement data, a sensing result, and the like that are transmitted based on a user plane. It may be understood that the sensing-related information can provide richer information than the sensing content.

Optionally, the sensing interception product may further include at least one of the following: a timestamp, used to indicate time of obtaining the at least one of the sensing-related information and the sensing content; and location information, used to indicate a location of the target of interception at the time of obtaining the at least one of the sensing-related information and the sensing content. It should be noted that, in a case that the target of interception is 3GPP user equipment or is associated with 3GPP user equipment, a network side may provide location information of the target of interception, for example, a mobile network cell ID or geographic coordinates corresponding to the target of interception.

The first node may obtain the sensing interception product of the target of interception based on the interception information, and send the sensing interception product to the lawful interception node. For example, in a case that the first node is a point of interception (for example, an AMF, an SMF, a UPF, a UDM, an NRF, an NEF, an SMSF, or an IMS), the first node may intercept the corresponding sensing interception product based on the interception information, and send the intercepted sensing interception product to the lawful interception node; and in a case that the first node is the receiving node of the sensing result, the first node may send, to a lawful interception system, a sensing interception product that is corresponding to the interception information and that is in the sensing result received by the first node.

According to the interception method provided in this embodiment of this application, the first node obtains the interception information, where the interception information is used to indicate to intercept sensing of the target of interception; and the first node sends the sensing interception product of the target of interception to the lawful interception node based on the interception information. In this way, the lawful interception node can intercept sensing of the target of interception.

Optionally, the interception information includes at least one of a target identifier and a service type, the target identifier is used to identify the target of interception, and the service type includes at least one of sensing and a lawful access sensing service.

In actual application, at least one of sensing and the lawful access sensing service may be added to a service type (CSP service type) of a communication service provider. The sensing may be understood as that the communication service provider provides a sensing service in addition to services such as voice and data. The lawful access sensing service is used to provide lawful access to target sensing, and the target sensing may be understood as sensing of the target of interception.

Optionally, a network function that supports the lawful access sensing service preferentially processes a request of the lawful access sensing service, and/or a privacy override indicator of the target of interception to be intercepted in the lawful access sensing service is set to “override”.

That the network function that supports the lawful access sensing service preferentially processes the request for the lawful access sensing service may be understood as follows: a priority of the network function that supports the lawful access sensing service to process the request of the lawful access sensing service is higher than a priority of the network function that supports the lawful access sensing service to process a request of another service, where the another service may be understood as a service other than the lawful access sensing service (in other words, the lawful interception node requests a network to perform sensing on the target of interception), for example, a service other than the lawful access sensing service (for example, a network external application function requests the network to perform sensing on the target of interception) in services supported by the communication service provider.

The privacy override indicator of the target of interception to be intercepted in the lawful access sensing service is set to “override”. To be specific, regardless of whether privacy of the target of interception is set to content such as “sensing allowed” or “sensing prohibited”, the network function provides sensing of the target of interception for the lawful access sensing service.

Optionally, the target identifier includes at least one of the following: a sensing target identifier, a sensing area identifier, an identifier of a sending node of a sensing request, and an identifier of a receiving node of a sensing result.

In this embodiment, the sensing target identifier is used to identify a sensing target, and the sensing target may include a device that has a capability of sending or receiving a wireless signal, for example, a device (for example, a mobile phone, an automobile, or an unmanned aerial vehicle) that supports access to a mobile network or a tag device for backscattering. The sensing target may also include an object that does not have the capability of sending or receiving a wireless signal, for example, a human, an animal, a plant, or an automobile or an unmanned aerial vehicle that does not have a communication capability.

Optionally, in a case that the sensing target is a device that has a signal sending or receiving capability, the sensing target identifier includes at least a device identifier; and
in a case that the sensing target is an object that does not have the signal sending or receiving capability, the sensing target identifier includes at least one of geographic location information and time information.

For example, in a case that the sensing target is a device that has the signal sending or receiving capability, if the sensing target is a device (for example, UE) that supports access to the mobile network, the device identifier may include a SUPI, a PEI, a GPSI, an IP multimedia private identity (IMPI), an IP multimedia public identity (IMPU), and the like. If the sensing target is a tag device for backscattering, the device identifier may include a tag identity (TAG ID) of the tag device.

It should be noted that the IMPI is used for registration, authentication, authorization, and accounting of access by a user to an IMS network, and is not used for addressing and routing of paging. A user identity defined by a home network operator has global uniqueness; in other words, one private identity (that is, an IMPI) corresponds to one physical terminal. A format of the IMPI is username@domain, for example, +8618652476314@ims.sz.cn. The IMPU is used for routing of a session initialization protocol (SIP) message. One IMS user may be allocated with one or more public subscriber identities (that is, IMPUs). A format of the public subscriber identity may be in a format such as a SIP URI or a Tel URL. Before the IMPU is used to initiate a session or used as a session terminator, the IMPU needs be registered first. A format of the IMPU is a SIP URI, for example, “Sip: user1@ims.fj.chinamobile.com”, or a TEL URI, for example, “Tel: +8613904710100”

In a case that the sensing target is an object that does not have the signal sending or receiving capability (for example, a human, an animal, a plant, or an automobile or an unmanned aerial vehicle that does not have the communication capability), the sensing target identifier includes at least one of geographic location information and time information, for example, geographic location coordinates (longitude, latitude, and altitude). It may be understood that, if immediate sensing (immediate sensing) in which sensing is immediately intercepted after an interception request is received is performed, the time information may not be required, or otherwise, the time information may be further added to identify the sensing target. The time information may be time point information, or may be time interval information, for example, a time point at a specific year, month, day, hour, minute, and second.

Optionally, the sensing area identifier includes at least one of the following:
longitude, latitude, and altitude ranges;
an area identifier used by a mobile network;
a static reference point and first information, where the first information includes at least one of a distance range, an angle range, and an altitude range; and
a dynamic reference point and second information, where the second information includes at least one of a distance range, an angle range, and an altitude range.

In this embodiment, the sensing area may be identified by using reference coordinates. In an implementation, a sensing area may be identified by longitude, latitude, and altitude ranges, for example, 30 degrees north latitude to 31 degrees north latitude, 120 degrees east longitude to 121 degrees east longitude, and an altitude being 5 meters to 200 meters above sea level.

In another implementation, the sensing area may be identified by using the area identifier used by the mobile network. For example, the sensing area may be represented based on at least one of a routing area (RA), a tracking area (TA), an RAN-based Notification Area (RNA), and the like, for example, a TAI and an RAN-based Notification Area Code (RANAC), where the TAI and the RANAC are a PLMAN ID, a tracking area code (TAC) (a unique identifier in a public land mobile network (PLMN)), the RANAC, and the like.

In another implementation, the sensing area may be identified based on the static reference point and the first information, and the static reference point may include a static object such as a base station or a building. It may be understood that at least one of the distance range, the angle range, and the altitude range may be described relative to the static reference point. For example, the sensing area may be an area within a range of 100 meters centered on the static reference point, or the sensing area may be an area within a range that uses the static reference point as an origin of a reference coordinate system, whose angle relative to a specific axis of the reference coordinates is X1 degrees to Y1 degrees, and whose distance from the static reference point is M1 meters to N1 meters. X1, Y1, M1, and N1 each are a positive integer.

It should be noted that the foregoing sensing area based on an identifier of the base station may be referred to as an RAN-node-based area. In actual application, the sensing area is sometimes smaller than the RA, the TA, the RNA, and the like, or even smaller than an area of one cell. Therefore, the sensing area may be represented by a vertical distance, a horizontal distance, an angle range, an altitude range, and the like by using a location of the base station as an origin of a reference coordinate system. In an optional implementation, a coverage range of the base station is divided into a plurality of areas, and different areas are defined as different RAN-node-based area codes, so that the sensing area may be represented by the RAN-node-based area code.

In another implementation, the sensing area may be identified based on the dynamic reference point and the second information, and the dynamic reference point may include a movable object such as UE, an automobile, or an unmanned aerial vehicle. It may be understood that at least one of the distance range, the angle range, and the altitude range may be described relative to the dynamic reference point. For example, the sensing area may be an area within a range of 50 meters centered on the dynamic reference point, or the sensing area may be an area within a range that uses the dynamic reference point as an origin of reference coordinates, whose angle relative to a specific axis of the reference coordinates is X2 degrees to Y2 degrees, and whose distance from the dynamic reference point is M2 meters to N2 meters. X2, Y2, M2, and N2 each are a positive integer. For example, if a location of the UE is used as the dynamic reference point, an object (for example, an obstacle or a moving object) within a range of 50 meters around the UE may be sensed.

It should be noted that, for a location or a track of the dynamic reference point, the first node may obtain the location or the track of the dynamic reference point, or the first node may receive the location or the track of the dynamic reference point from the outside. This is not limited in this embodiment.

Optionally, in a case that a target node is a device that is based on 3rd Generation Partnership Project 3GPP access, an identifier of the target node includes a device identifier; and
in a case that the target node is an application server or an application function, the identifier of the target node includes at least one of an internet protocol (IP) address, a media access control (MAC) address, and a port number; where
the target node includes the sending node of the sensing request or the receiving node of the sensing result.

In this embodiment, in a case that the sending node of the sensing request or the receiving node of the sensing result is a 3GPP access-based device (for example, UE), the identifier of the target node includes a device identifier, for example, a SUPI, a PEI, a GPSI, an IMPI, and an IMPU. In a case that the sending node of the sensing request or the receiving node of the sensing result is a wired network-based application server, a non-3GPP access based application function, or the like, the identifier of the target node includes at least one of an IP address, a MAC address, a port number, and the like.

It should be noted that, when the sending node of the sensing request or the receiving node of the sensing result is a wired network-based application server, a non-3GPP access-based application function, or the like, the network function node or the lawful interception node needs to be capable of obtaining a correspondence (for example, 118.143.233.73 corresponds to a company A) between at least one of an IP address, a MAC address, and a port number of the wired network-based application server or the non-3GPP access-based application function and the sending node of the sensing request or the receiving node of the sensing result, the network function node may convert, based on the correspondence, the sending node (for example, the company A) of the sensing request to be intercepted or the receiving node of the sensing result into an identifier that can be identified by the network, such as an IP address, a MAC address, or a port number that is used when a request from the company A is received. Correspondingly, the lawful interception node may map a sensing interception product of the identifier such as the IP address, the MAC address, or the port number to a sensing interception product corresponding to the sending node of the sensing request to be intercepted or the receiving node of the sensing result.

It should be further noted that the receiving node of the sensing result and the sending node of the sensing request may be a same node, or may be different nodes. In a case that the receiving node of the sensing result and the sending node of the sensing request are different nodes, an identifier of the receiving node of the sensing result and an identifier of the sending node of the sensing request may be identifiers of a same type, for example, the identifier of the receiving node of the sensing result is a SUPI, and the identifier of the sending node of the sensing request is also a SUPI; or an identifier of the receiving node of the sensing result and an identifier of the sending node of the sensing request may be identifiers of different types, for example, the identifier of the receiving node of the sensing result is a SUPI, and the identifier of the sending node of the sensing request is a GPSI.

Optionally, the interception information further includes at least one of the following:
a type of intercept, where the type of intercept includes at least one of sensing-related information and sensing content;
a service scoping, where the service scoping includes sensing;
filtering criteria, where the filtering criteria include at least one of time information, geographic location information, and a sensing performance indicator; and
a sensing data category.

The type of intercept may include at least one of the sensing-related information and the sensing content. In a case that the type of intercept includes only the sensing-related information, only the sensing-related information is intercepted. In a case that the type of intercept includes only the sensing content, only the sensing content is intercepted. In a case that the type of intercept includes the sensing-related information and the sensing content, both the sensing-related information and the sensing content are intercepted. Optionally, the type of intercept may further include at least one of communication-related information and communication content. In other words, in addition to at least one of the sensing-related information and the sensing content, at least one of the communication-related information and the communication content further needs to be intercepted. It should be noted that at least one of the sensing-related information and the sensing content is for sensing, and at least one of the communication-related information and the communication content is for communication, for example, voice, a data packet, messaging, or target positioning.

In some scenarios, both the sensing-related information and the communication-related information may be referred to as an IRI, and both the sensing content and the communication content may be referred to as a CC. To be specific, the type of intercept includes IRI only, CC only, or both IRI and CC. The IRI includes at least one of the sensing-related information and the communication-related information, and the CC includes at least one of the sensing content and the communication content.

The service scoping is used to indicate a service to be intercepted, and the service scoping includes sensing. Optionally, the service scoping may further include at least one of voice, a data packet, messaging, target positioning, and the like.

The filtering criteria are used to provide additional information for interception, for example, for bandwidth optimization. The filtering criteria include at least one of time information, geographic location information, and a sensing performance indicator. Optionally, the sensing performance indicator includes at least one of the following: sensing accuracy, sensing resolution, and sensing update frequency. For a meaning of the sensing performance indicator, reference may be made to Table 2. Details are not described herein again.

The sensing data category is used to indicate sensing data to be intercepted, and the sensing data category includes at least one of the sensing measurement data (the first-level measurement quantity and/or the second-level measurement quantity) and the sensing result (the third-level measurement quantity and/or the fourth-level measurement quantity). For details of the first-level measurement quantity, the second-level measurement quantity, the third-level measurement quantity, and the fourth-level measurement quantity, reference may be made to the foregoing related description. Details are not described herein again. For example, in a case that the sensing data category includes the sensing measurement data, only sensing measurement data of the target of interception may be intercepted, and in a case that the sensing data category includes the sensing measurement data and the sensing result, the sensing measurement data of the target of interception and the sensing result may be intercepted.

Optionally, in a case that the first node is a network function node for network layer based interception, the sensing-related information event includes at least one of the following:
exchanging sensing information, where the sensing information includes at least one of a sensing request, a sensing response, a sensing configuration, a sensing report, and a sensing result that are related to the target of interception;
establishing, modifying, or releasing a communication channel used for lawful interception on sensing;
enabling interception on a first communication channel, where the first communication channel is any established communication channel used for lawful interception on sensing; and
stopping interception on a second communication channel, where the second communication channel is any established communication channel used for lawful interception on sensing.

In this embodiment, the network function node may include an AMF, an SF, an SMF, an NRF, an SMSF, or the like. It should be noted that, for the foregoing sensing information exchanging event, when an IRI-POI existing in the network function node (for example, an AMF or a sensing function) detects the sensing information exchanging event or information, an IRI report, that is, xIRI, is generated.

It should be noted that for network layer based interception, lawful interception may be sensed by the AMF by intercepting a sensing request, a sensing response, or a sensing report that is of network-based sensing and that is exchanged between an SF and an NG-RAN through the AMF and related to the target of interception, or a sensing request, a sensing response, or a sensing report that is of UE-based or UE-assisted sensing and that is exchanged between an SF and UE through the AMF and related to the target of interception.

Optionally, the exchanging sensing information includes at least one of the following:
the network function node exchanges, with an access network device, at least one of the sensing request, the sensing response, the sensing configuration, and the sensing report that are related to the target of interception;
the network function node exchanges, with a terminal, at least one of the sensing request, the sensing response, the sensing configuration, and the sensing report that are related to the target of interception; and
the network function node exchanges, with an application function (AF), at least one of the sensing request, the sensing response, and the sensing result that are related to the target of interception.

The target of interception may include at least one of the sensing target, the sensing area, the sending node of the sensing request, and the receiving node of the sensing result. The access network device is, for example, a next generation radio access network (NG-RAN) device.

For the establishing, modifying, or releasing a communication channel used for lawful interception on sensing, for example, a protocol data unit (PDU) session (that is, a PDU session) used for sensing data transmission is established, modified, or released. For the enabling interception on a first communication channel, for example, interception on an established PDU session used for sensing data transmission is enabled. For the stopping interception on a second communication channel, for example, interception on an established PDU session used for sensing data transmission is stopped. It should be noted that when the IRI-POI existing in the network function node (for example, an SMF/UPF or an SF) detects an event or information of sensing data transmission, an IRI report, that is, xIRI, is generated.

Optionally, in a case that the first node is a network function node for service layer based interception, a sensing-related information event includes at least one of the following:
a sensing request for the target of interception;
a sensing response for the target of interception;
a sensing report for the target of interception; and
sensing quality of service QoS information of the target of interception.

In this embodiment, the network function node may include an NEF, a common application programming interface (API) framework for 3GPP northbound APIs (Common API Framework for 3GPP Northbound APIs, CAPIF), an IMS, and the like.

For example, the sensing request of the target of interception requests to sense a track of excepted UE, or requests to sense environment construction information or the like of an area of the target of interception, or the target of interception sends the sensing request to the network. For the sensing response for the target of interception, for example, the network accepts or rejects a corresponding sensing request by using the sensing response. The sensing report for the target of interception is used to carry at least one of the sensing measurement data and the sensing result, for example, send at least one of the sensing measurement data and the sensing result to a network external function (for example, an external application function). For the sensing QoS information of the target of interception, for example, the target of interception sends a sensing QoS requirement or updates a sensing QoS requirement to the network.

In some optional embodiments, that the sensing-related information event includes at least one of the sensing request for the target of interception, the sensing response for the target of interception, the sensing report for the target of interception, and the QoS information of the target of interception may be understood as follows: The sensing-related information event includes at least one of an event related to the sensing request for the target of interception (for example, the target of interception sends the sensing request to the network), an event related to the sensing response for the target of interception (for example, the network accepts or rejects the corresponding sensing request by using the sensing response), an event related to the sensing report for the target of interception (for example, the sensing report for the target of interception is sent to the network external function), and an event related to the QoS information of the target of interception (for example, the target of interception sends the sensing QoS requirement or updates the sensing QoS requirement to the network).

It should be noted that when the IRI-POI (for example, the NEF) existing in the network function node detects the sensing-related information event or the information, the IRI-POI sends the generated IRI report (that is, xIRI) to a sensing interception node. The IRI may also be referred to as a sensing-related information report.

It should also be noted that the service layer based interception includes a sensing report in a case that the network or the user normally uses a sensing service, and a sensing report of the lawful access sensing service. The sensing report in the case that the network or the user normally uses the sensing service may be used as auxiliary data for other lawful interception (for example, voice or a short messaging service message), and embedded sensing reporting or separated sensing reporting may be used. The embedded sensing reporting means that sensing information of the target of interception is provided when another interception product (for example, voice or a short messaging service message) is provided, and time of the sensing information is embedded into a report before being provided, for example, sensing information of a physiological feature such as gait recognition may be used as auxiliary data of the target of interception to further identify the target of interception. The lawful access sensing service provides sensing information of lawful access to the target of interception. As described above, the target of interception includes at least one of the sensing target, the sensing area, the sending node of the sensing request, and the receiving node of the sensing result. For detailed explanation of the lawful access sensing service, reference may be made to related descriptions in the foregoing embodiment. Details are not described herein again.

Further, the lawful access sensing service may be classified into two types: target sensing and triggered sensing. The target sensing refers to sensing of a service performed independently of the target of interception. In other words, the target of interception is sensed regardless of a service (for example, voice, a data packet, or a short messaging service message) performed by the target of interception. The triggered sensing refers to sensing of the target of interception in a case that a network or a service event related to the target of interception is detected (for example, a location of the target of interception is updated, and the target of interception is in a voice call).

Currently, in network information exposure, network information is usually provided to the external application function by using the NEF or the common API framework for 3GPP northbound APIs (CAPIF). Therefore, an optional manner of providing the sensing service for the network external function is providing the sensing service based on the NEF. Therefore, from a perspective of an external service, the NEF can be used as a POI to support lawful interception on sensing, and is mainly oriented to a case that the network provides sensing information to an application function (AF) by using the NEF. If interception is performed on a target, the target identifier may be at least one of the sensing target, the sensing area, the sending node of the sensing request, and the receiving node of the sensing result. If interception is performed on all targets related to sensing, the target identifier is used to identify all the targets related to sensing.

Optionally, in a case that the target identifier includes the sensing area identifier, the method further includes:
receiving, by the first node, first indication information, where
the first indication information is used to indicate at least one of the following:
a first sensing area is the same as a second sensing area, the first sensing area is a sensing area indicated by the sensing area identifier, and the second sensing area is a sensing area that a sensing request requests to sense;
the first sensing area includes the second sensing area;
the second sensing area includes the first sensing area; and
the first sensing area partially overlaps the second sensing area.

In this embodiment, a dynamic change of the sensing area, area overlapping, or a relationship such as inclusion by an area or an area being included may be taken into consideration when lawful interception is performed on the sensing area. Specifically, the first sensing area is a sensing area indicated by the target identifier, that is, a sensing area to be intercepted, and the second sensing area is a sensing area indicated by the sensing request.

That the first sensing area partially overlaps the second sensing area may be understood as follows: An overlapping area exists between the first sensing area and the second sensing area, and there is no inclusion relationship between the first sensing area and the second sensing area. In other words, the first sensing area is not completely included in the second sensing area, and the second sensing area is not completely included in the first sensing area, either.

Optionally, in a case that the first node receives the first indication information (for example, the first indication information indicates that the first area is the same as the second area, or the first area includes the second area), sensing may be intercepted based on the first indication information. For example, the first node determines, based on the first indication information, a relationship between the sensing area indicated by the received sensing request and a sensing area indicated by an identifier of the target of interception, and sensing data related to the sensing request is intercepted only in a case that the first sensing area is the same as the second sensing area or the second sensing area includes the first sensing area, thereby implementing interception on the first sensing area, to obtain the sensing interception product. It should be noted that a sensing area indicated by an identifier of one target of interception may correspond to one or more sensing areas indicated by the sensing request that meets the first indication information.

Referring to FIG. 5, FIG. 5 is a flowchart of an interception method according to an embodiment of this application. The method may be performed by a network side device. As shown in FIG. 5, the method includes the following steps.

Step 501: A lawful interception node sends interception information, where the interception information is used to indicate to intercept sensing of a target of interception.

Step 502: The lawful interception node receives a sensing interception product of the target of interception from a first node.

Optionally, the interception information includes at least one of a target identifier and a service type, the target identifier is used to identify the target of interception, and the service type includes at least one of sensing and a lawful access sensing service.

Optionally, the target identifier includes at least one of the following: a sensing target identifier, a sensing area identifier, an identifier of a sending node of a sensing request, and an identifier of a receiving node of a sensing result.

Optionally, in a case that a sensing target is a device that has a signal sending or receiving capability, the sensing target identifier includes a device identifier; and
in a case that the sensing target is an object that does not have the signal sending or receiving capability, the sensing target identifier includes at least one of geographic location information and time information.

Optionally, the sensing area identifier includes at least one of the following:
longitude, latitude, and altitude ranges;
an area identifier used by a mobile network;
a static reference point and first information, where the first information includes at least one of a distance range, an angle range, and an altitude range; and
a dynamic reference point and second information, where the second information includes at least one of a distance range, an angle range, and an altitude range.

Optionally, in a case that a target node is a device that is based on 3rd Generation Partnership Project 3GPP access, an identifier of the target node includes a device identifier; and
in a case that the target node is an application server or an application function, the identifier of the target node includes at least one of an internet protocol IP address, a media access control MAC address, and a port number; where
the target node includes the sending node of the sensing request or the receiving node of the sensing result.

Optionally, a network function that supports the lawful access sensing service preferentially processes a request of the lawful access sensing service;
and/or
a privacy override indicator of the target of interception to be intercepted in the lawful access sensing service is set to “override”.

Optionally, the interception information further includes at least one of the following:
a type of intercept, where the type of intercept includes at least one of sensing-related information and sensing content;
a service scoping, where the service scoping includes sensing;
filtering criteria, where the filtering criteria include at least one of time information, geographic location information, and a sensing performance indicator; and
a sensing data category.

Optionally, the sensing interception product includes at least one of sensing-related information and sensing content.

Optionally, the sensing interception product further includes at least one of the following:
a timestamp, used to indicate time of obtaining the at least one of the sensing-related information and the sensing content; and
location information, used to indicate a location of the target of interception at the time of obtaining the at least one of the sensing-related information and the sensing content.

Optionally, in a case that the target identifier includes the sensing area identifier, the method further includes:
sending, by the lawful interception node, first indication information to the first node, where
the first indication information is used to indicate at least one of the following:
a first sensing area is the same as a second sensing area, the first sensing area is a sensing area indicated by the sensing area identifier, and the second sensing area is a sensing area that a sensing request requests to sense;
the first sensing area includes the second sensing area;
the second sensing area includes the first sensing area; and
the first sensing area partially overlaps the second sensing area.

Optionally, the method further includes:
receiving, by the lawful interception node, an association relationship between a first identifier and the target identifier, where the first identifier includes at least one of a temporary identifier of the target of interception and a network internal identifier, the first identifier is used when sensing data of the target of interception is exchanged between network function nodes through an interface, and the target identifier is used to identify at least one of a sensing target, a sensing area, a sending node of a sensing request, and a receiving node of a sensing result.

Considering that a 3GPP network uses a temporary identifier to replace a permanent identifier to ensure that the permanent identifier is not exposed to some interfaces (for example, RAN-related interfaces), a case that a user is being tracked, disclosure of privacy, or the like is avoided. In addition, the sensing target identifier, the sensing area identifier, the identifier of the sending node of the sensing request, and the identifier of the receiving node of the sensing result in lawful interception on sensing are not exposed on some network interfaces, either, and may even be converted into other identifiers. For example, an identifier of a specific sensing area is converted into a plurality of sensing request identifiers to be sent to a plurality of base stations, and similarly, different sensing requests sent by a same sensing request sender may also be mapped to a plurality of sensing task identifiers used within a network. Therefore, to perform lawful interception on the target of interception, a communication service provider needs to provide an association relationship between a network internal identifier and/or a temporary identifier and the target identifier.

Optionally, the association relationship between the first identifier and the target identifier is indicated by using an identifier event, and the identifier event includes:
a subscription permanent identifier, where the subscription permanent identifier is the target identifier; and
an observed first identifier, where the observed first identifier is used when the sensing data of the target of interception is exchanged between the network function nodes through the interface.

The subscription permanent identifier is used to identify at least one of the sensing target, the sensing area, the sending node of the sensing request, and the receiving node of the sensing result. The observed first identifier includes at least one of an observed temporary identifier and an observed network internal identifier, and at least one of the observed temporary identifier and the observed network internal identifier is used when sensing information to be intercepted is exchanged between network function nodes through an interface (that is, within the network).

Optionally, the identifier event further includes at least one of the following:
a timestamp of the identifier event, used to indicate occurrence time of the identifier event;
a network function identifier, used to indicate a network function that generates an identifier event report; and
geographic location information, used to indicate a geographic location of the target of interception at the time of sending the identifier event.

The geographic location information may include but is not limited to a TAI, a RA, an RNA, a RAN-node-based area code, geographic location coordinates, or the like. It should be noted that, in a case that the target of interception is 3GPP user equipment or is associated with 3GPP user equipment, a network side may provide geographic location information of the target of interception.

It should be noted that for an implementation of this implementation, reference may be made to related descriptions of the embodiment shown in FIG. 4. Details are not described herein again.

The embodiments of this application are described below with reference to examples.

### Example 1

A lawful interception node (for example, an LEA) sends a warrant and other interception request information (that is, the foregoing interception information) to a communication service provider, for example, a network function node of the communication service provider (for example, an LICF in an ADMF), through an interface (for example, LI_HI1). For lawful interception on sensing, at least one piece of the following information (that is, the interception information) needs to be sent on the foregoing interface: a target identifier, a type of intercept, a service scoping, and filtering criteria. It should be noted that for detailed explanation of the foregoing interception information, reference may be made to related descriptions in the foregoing embodiments. Details are not described herein again.

The network function node of the communication service provider obtains a required sensing interception product from a corresponding POI based on the received warrant and other interception request information, and sends the required sensing interception product to the lawful interception node.

### Example 2

In a communication service, information is exchanged based on 3GPP user equipment, and in a sensing service, a wider range of targets and areas may be sensed, and a sensed target or area may be unaware of being sensed at all. Therefore, when sensing is performed by using widely distributed base stations and/or UE, users and social institutions perceive a potential privacy risk as high. Therefore, on the basis of reputation of a communication service provider, lawful interception performed by using a third party (a third party other than a sensing service provider and a sensing service user, such as the Ministry of Industry and Information Technology) helps provide additional supervision on the communication service provider and reduce a risk of abuse of sensing. It should be noted that a sensing interception product obtained based on lawful interception performed by the third party may also serve target lawful interception in a warrant-oriented case.

Specifically, a third-party lawful interception node may send interception information to a network function node and/or the sensing service user (for example, a sending node of a sensing request or a receiving node of a sensing result), and the interception information includes at least one of the following:
a target identifier, a type of intercept, and a sensing data category. It should be noted that the target identifier in this example needs to indicate all targets related to sensing; in other words, all the targets related to sensing, rather than a specific target as in Example 1, need to be lawfully intercepted. In addition, the type of intercept in this example needs to indicate sensing-related information and sensing content; in other words, all sensing-related information and all sensing content need to be provided to the third-party lawful interception node.

The network function node and/or the sensing service user may obtain the required sensing interception product based on the foregoing interception information. Specifically, the sensing interception product may include the sensing-related information, the sensing content, a timestamp used to indicate time of obtaining the at least one of the sensing-related information and the sensing content, and location information used to indicate a location of a target of interception at the time of obtaining the at least one of the sensing-related information and the sensing content. It should be noted that, in a case that the sensing-related information and the sensing content do not include an identifier of a sending node of sensing data or an identifier of a receiving node of the sensing data, the sensing interception product further needs to include the identifier of the sending node of the sensing data or the identifier of the receiving node of the sensing data.

It may be learned from the foregoing descriptions that, according to the interception method provided in this embodiment of this application, lawful interception for a sensing service and/or an integrated communication and sensing service may be implemented, lawful interception for a sensing target, a sensing area, sensing-related information of the sensing service user, and/or sensing content may be supported, and a lawful access sensing service may be supported. In this application, not only interception for sensing of a specific target is supported, but interception for a total quantity of sensing services is also supported, so that not only lawful interception in a conventional warrant-oriented case can be met, but supervision by the third party over provision of the sensing service can also be met, thereby helping improve security of the sensing service and protect user privacy.

It should be noted that the interception method provided in the embodiments of this application may be performed by an interception apparatus, or a control module that is in the interception apparatus and that is configured to perform the interception method. In the embodiments of this application, the interception apparatus provided in the embodiments of this application is described by using an example in which the interception apparatus performs the interception method.

Referring to FIG. 6, FIG. 6 is a structural diagram of an interception apparatus according to an embodiment of this application. As shown in FIG. 6, an interception apparatus 600 includes:
an obtaining module 601, configured to obtain interception information, where the interception information is used to indicate to intercept sensing of a target of interception; and
a first sending module 602, configured to send a sensing interception product of the target of interception to a lawful interception node based on the interception information.

Optionally, the interception information includes at least one of a target identifier and a service type, the target identifier is used to identify the target of interception, and the service type includes at least one of sensing and a lawful access sensing service.

Optionally, the target identifier includes at least one of the following: a sensing target identifier, a sensing area identifier, an identifier of a sending node of a sensing request, and an identifier of a receiving node of a sensing result.

Optionally, in a case that a sensing target is a device that has a signal sending or receiving capability, the sensing target identifier includes a device identifier; and
in a case that the sensing target is an object that does not have the signal sending or receiving capability, the sensing target identifier includes at least one of geographic location information and time information.

Optionally, the sensing area identifier includes at least one of the following:
longitude, latitude, and altitude ranges;
an area identifier used by a mobile network;
a static reference point and first information, where the first information includes at least one of a distance range, an angle range, and an altitude range; and
a dynamic reference point and second information, where the second information includes at least one of a distance range, an angle range, and an altitude range.

Optionally, in a case that a target node is a device that is based on 3rd Generation Partnership Project 3GPP access, an identifier of the target node includes a device identifier; and
in a case that the target node is an application server or an application function, the identifier of the target node includes at least one of an internet protocol IP address, a media access control MAC address, and a port number; where
the target node includes the sending node of the sensing request or the receiving node of the sensing result.

Optionally, a network function that supports the lawful access sensing service preferentially processes a request of the lawful access sensing service;
and/or
a privacy override indicator of the target of interception to be intercepted in the lawful access sensing service is set to “override”.

Optionally, the interception information further includes at least one of the following:
a type of intercept, where the type of intercept includes at least one of sensing-related information and sensing content;
a service scoping, where the service scoping includes sensing;
filtering criteria, where the filtering criteria include at least one of time information, geographic location information, and a sensing performance indicator; and
a sensing data category.

Optionally, the sensing performance indicator includes at least one of the following: sensing accuracy, sensing resolution, and sensing update frequency.

Optionally, the sensing interception product includes at least one of sensing-related information and sensing content.

Optionally, the sensing interception product further includes at least one of the following:
a timestamp, used to indicate time of obtaining the at least one of the sensing-related information and the sensing content; and
location information, used to indicate a location of the target of interception at the time of obtaining the at least one of the sensing-related information and the sensing content.

Optionally, in a case that the first node is a network function node for network layer based interception, a sensing-related information event includes at least one of the following:
exchanging sensing information, where the sensing information includes at least one of a sensing request, a sensing response, a sensing configuration, a sensing report, and a sensing result that are related to the target of interception;
establishing, modifying, or releasing a communication channel used for lawful interception on sensing;
enabling interception on a first communication channel, where the first communication channel is any established communication channel used for lawful interception on sensing; and
stopping interception on a second communication channel, where the second communication channel is any established communication channel used for lawful interception on sensing.

Optionally, the exchanging sensing information includes at least one of the following:
the network function node exchanges, with an access network device, at least one of the sensing request, the sensing response, the sensing configuration, and the sensing report that are related to the target of interception;
the network function node exchanges, with a terminal, at least one of the sensing request, the sensing response, the sensing configuration, and the sensing report that are related to the target of interception; and
the network function node exchanges, with an application function, at least one of the sensing request, the sensing response, and the sensing result that are related to the target of interception.

Optionally, in a case that the first node is a network function node for service layer based interception, a sensing-related information event includes at least one of the following:
a sensing request for the target of interception;
a sensing response for the target of interception;
a sensing report for the target of interception; and
sensing quality of service QoS information of the target of interception.

Optionally, in a case that the target of interception includes a first sensing area, the apparatus further includes:
a receiving module, configured to receive first indication information, where
the first indication information is used to indicate at least one of the following:
the first sensing area is the same as a second sensing area, the first sensing area is a sensing area indicated by the sensing area identifier, and the second sensing area is a sensing area that a sensing request requests to sense;
the first sensing area includes the second sensing area;
the second sensing area includes the first sensing area; and
the first sensing area partially overlaps the second sensing area.

The interception apparatus in this embodiment of this application may be an electronic device, for example, an electronic device with an operating system, or may be a component such as an integrated circuit or a chip in the electronic device. For example, the electronic device may be a network side device, or may be another device other than the network side device. For example, the network side device may include but is not limited to the types of the network side device 12 listed above, and the another device may be a server, a network attached storage (NAS), or the like. This is not specifically limited in this embodiment of this application.

The interception apparatus provided in this embodiment of this application can implement the processes implemented in the method embodiment in FIG. 4, and a same technical effect is achieved. To avoid repetition, details are not described herein again.

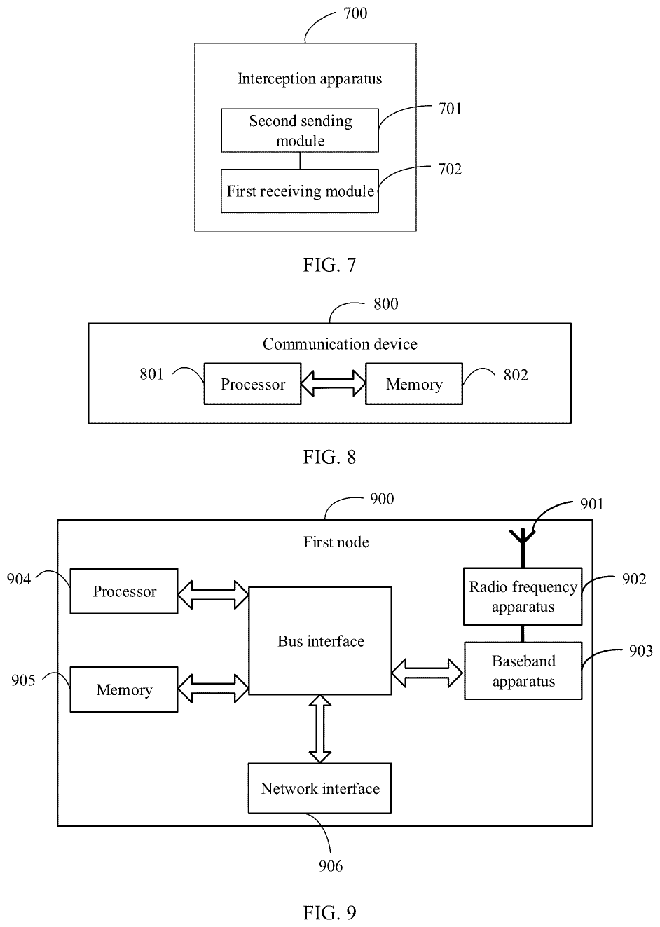

Referring to FIG. 7, FIG. 7 is a structural diagram of an interception apparatus according to an embodiment of this application. As shown in FIG. 7, an interception apparatus 700 includes:
a second sending module 701, configured to send interception information, where the interception information is used to indicate to intercept sensing of a target of interception; and
a first receiving module 702, configured to receive a sensing interception product of the target of interception from a first node.

Optionally, the interception information includes at least one of a target identifier and a service type, the target identifier is used to identify the target of interception, and the service type includes at least one of sensing and a lawful access sensing service.

Optionally, the target identifier includes at least one of the following: a sensing target identifier, a sensing area identifier, an identifier of a sending node of a sensing request, and an identifier of a receiving node of a sensing result.

Optionally, in a case that a sensing target is a device that has a signal sending or receiving capability, the sensing target identifier includes a device identifier; and
in a case that the sensing target is an object that does not have the signal sending or receiving capability, the sensing target identifier includes at least one of geographic location information and time information.

Optionally, the sensing area identifier includes at least one of the following:
longitude, latitude, and altitude ranges;
an area identifier used by a mobile network;
a static reference point and first information, where the first information includes at least one of a distance range, an angle range, and an altitude range; and
a dynamic reference point and second information, where the second information includes at least one of a distance range, an angle range, and an altitude range.

Optionally, in a case that a target node is a device that is based on 3rd Generation Partnership Project 3GPP access, an identifier of the target node includes a device identifier; and
in a case that the target node is an application server or an application function, the identifier of the target node includes at least one of an internet protocol IP address, a media access control MAC address, and a port number; where
the target node includes the sending node of the sensing request or the receiving node of the sensing result.

Optionally, a network function that supports the lawful access sensing service preferentially processes a request of the lawful access sensing service;
and/or
a privacy override indicator of the target of interception to be intercepted in the lawful access sensing service is set to “override”.

Optionally, the interception information further includes at least one of the following:
a type of intercept, where the type of intercept includes at least one of sensing-related information and sensing content;
a service scoping, where the service scoping includes sensing;
filtering criteria, where the filtering criteria include at least one of time information, geographic location information, and a sensing performance indicator; and
a sensing data category.

Optionally, the sensing interception product includes at least one of sensing-related information and sensing content.

Optionally, the sensing interception product further includes at least one of the following:
a timestamp, used to indicate time of obtaining the at least one of the sensing-related information and the sensing content; and
location information, used to indicate a location of the target of interception at the time of obtaining the at least one of the sensing-related information and the sensing content.

Optionally, in a case that the target identifier includes the sensing area identifier, the apparatus further includes:
a third sending module, configured to send first indication information to the first node, where
the first indication information is used to indicate at least one of the following:
a first sensing area is the same as a second sensing area, the first sensing area is a sensing area indicated by the sensing area identifier, and the second sensing area is a sensing area that a sensing request requests to sense;
the first sensing area includes the second sensing area;
the second sensing area includes the first sensing area; and
the first sensing area partially overlaps the second sensing area.

Optionally, the apparatus further includes:
a second receiving module, configured to receive an association relationship between a first identifier and the target identifier, where the first identifier includes at least one of a temporary identifier of the target of interception and a network internal identifier, the first identifier is used when sensing data of the target of interception is exchanged between network function nodes through an interface, and the target identifier is used to identify at least one of the sensing target, the sensing area, the sending node of the sensing request, and the receiving node of the sensing result.

Optionally, the association relationship between the first identifier and the target identifier is indicated by using an identifier event, and the identifier event includes:
a subscription permanent identifier, where the subscription permanent identifier is the target identifier; and
an observed first identifier, where the observed first identifier is used when the sensing data of the target of interception is exchanged between the network function nodes through the interface.

Optionally, the identifier event further includes at least one of the following:
a timestamp of the identifier event, used to indicate occurrence time of the identifier event;
a network function identifier, used to indicate a network function that generates an identifier event report; and
geographic location information, used to indicate a geographic location of the target of interception at the time of sending the identifier event.

The interception apparatus in this embodiment of this application may be an electronic device, for example, an electronic device with an operating system, or may be a component such as an integrated circuit or a chip in the electronic device. The electronic device may be a lawful interception node, or may be another device other than the lawful interception node. For example, the lawful interception node may include but is not limited to the foregoing types of the lawful interception node 13 listed above, and the another device may be a server, a network attached storage (NAS), or the like. This is not specifically limited in this embodiment of this application.

The interception apparatus provided in this embodiment of this application can implement the processes implemented in the method embodiment in FIG. 5, and a same technical effect is achieved. To avoid repetition, details are not described herein again.

Optionally, as shown in FIG. 8, an embodiment of this application further provides a communication device 800, including a processor 801 and a memory 802. The memory 802 stores a program or instructions capable of being run on the processor 801. For example, when the communication device 800 is a first node, the steps in the embodiment of the interception method on the first node side can be implemented when the program or the instructions are executed by the processor 801, and a same technical effect can be achieved. When the communications device 800 is a lawful interception node, the steps in the embodiment of the interception method on the lawful interception node side can be implemented when the program or the instructions are executed by the processor 801, and a same technical effect can be achieved. To avoid repetition, details are not described herein again.

An embodiment of this application further provides a first node, including a processor and a communication interface. The communication interface is configured to: obtain interception information, where the interception information is used to indicate to intercept sensing of a target of interception; and send a sensing interception product of the target of interception to a lawful interception node based on the interception information. This embodiment of the first node corresponds to the method embodiment on the first node side. Each implementation process and implementation in the foregoing method embodiment are applicable to the embodiment of the first node, and a same technical effect can be achieved.

Specifically, an embodiment of this application further provides a first node. As shown in FIG. 9, a first node 900 includes an antenna 901, a radio frequency apparatus 902, a baseband apparatus 903, a processor 904, and a memory 905. The antenna 901 is connected to the radio frequency apparatus 902. In an uplink direction, the radio frequency apparatus 902 receives information through the antenna 901, and sends the received information to the baseband apparatus 903 for processing. In a downlink direction, the baseband apparatus 903 processes to-be-sent information, and sends the processed information to the radio frequency apparatus 902. After processing the received information, the radio frequency apparatus 902 sends the processed information through the antenna 901.

The method performed by the first node in the foregoing embodiment may be implemented in the baseband apparatus 903, and the baseband apparatus 903 includes a baseband processor.

For example, the baseband apparatus 903 may include at least one baseband board. A plurality of chips are disposed on the baseband board. As shown in FIG. 9, one of the chips is, for example, the baseband processor, and is connected to the memory 905 by using a bus interface, to invoke a program in the memory 905 to perform an operation of the first node shown in the foregoing method embodiment.

The first node may further include a network interface 906, and the interface is, for example, a common public radio interface (CPRI).

Specifically, the first node 900 in this embodiment of this application further includes instructions or a program that is stored in the memory 905 and that is capable of being run on the processor 904. The processor 904 invokes the instructions or the program in the memory 905 to perform the method performed by the modules shown in FIG. 6, and a same technical effect is achieved. To avoid repetition, details are not described herein again.

An embodiment of this application further provides a lawful interception node, including a processor and a communication interface. The communication interface is configured to: send interception information, where the interception information is used to indicate to intercept sensing of a target of interception; and receive a sensing interception product of the target of interception from a first node. This embodiment of the lawful interception node corresponds to the foregoing method embodiment on the lawful interception node side. Each implementation process and implementation of the foregoing method embodiment are applicable to this embodiment of the lawful interception node, and a same technical effect can be achieved.

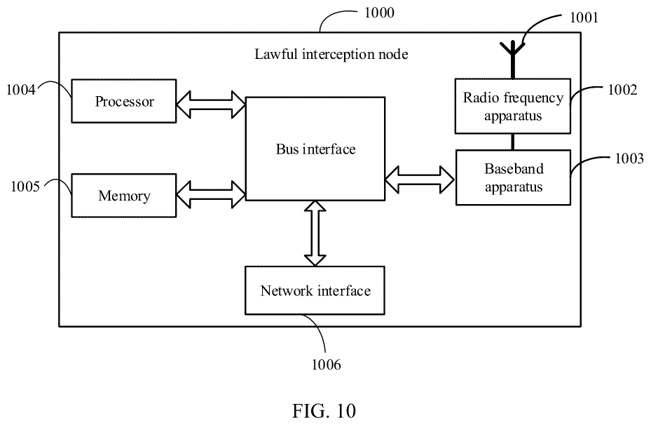

Specifically, an embodiment of this application further provides a lawful interception node. As shown in FIG. 10, a lawful interception node 1000 includes an antenna 1001, a radio frequency apparatus 1002, a baseband apparatus 1003, a processor 1004, and a memory 1005. The antenna 1001 is connected to the radio frequency apparatus 1002. In an uplink direction, the radio frequency apparatus 1002 receives information through the antenna 1001, and sends the received information to the baseband apparatus 1003 for processing. In a downlink direction, the baseband apparatus 1003 processes to-be-sent information, and sends the processed information to the radio frequency apparatus 1002. After processing the received information, the radio frequency apparatus 1002 sends the processed information through the antenna 1001.

The method performed by the lawful interception node in the foregoing embodiment may be implemented in the baseband apparatus 1003, and the baseband apparatus 1003 includes a baseband processor.

For example, the baseband apparatus 1003 may include at least one baseband board. A plurality of chips are disposed on the baseband board. As shown in FIG. 10, one of the chips is, for example, the baseband processor, and is connected to the memory 1005 by using a bus interface, to invoke a program in the memory 1005 to perform an operation of the lawful interception node shown in the foregoing method embodiment.

The lawful interception node may further include a network interface 1006, and the interface is, for example, a common public radio interface (CPRI).

Specifically, the lawful interception node 1000 in this embodiment of this application further includes instructions or a program that is stored in the memory 1005 and that is capable of being run on the processor 1004. The processor 1004 invokes the instructions or the program in the memory 1005 to perform the method performed by the modules shown in FIG. 7, and a same technical effect is achieved. To avoid repetition, details are not described herein again.

An embodiment of this application further provides a readable storage medium. The readable storage medium stores a program or instructions. When the program or the instructions are executed by a processor, the processes in the foregoing embodiment of the interception method on the first node side are implemented, or the processes in the foregoing embodiment of the interception method on the lawful interception node side are implemented, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface. The communication interface is coupled to the processor. The processor is configured to run a program or instructions to implement the processes in the foregoing embodiment of the interception method on the first node side or the processes in the foregoing embodiment of the interception method on the lawful interception node side, and a same technical effect can be achieved. To avoid repetition, details are not described herein again.

It should be understood that, the chip mentioned in this embodiment of this application may also be referred to as a system-level chip, a system chip, a chip system, or a system on chip.

An embodiment of this application further provides a computer program/program product. The computer program/program product is stored in a storage medium. The computer program/program product is executed by at least one processor to implement the processes in the foregoing embodiment of the interception method on the first node side or the processes in the foregoing embodiment of the interception method on the lawful interception node side, and a same technical effect can be achieved. To avoid repetition, details are not described herein again.

An embodiment of this application further provides a lawful interception system, including a first node and a lawful interception node. The first node is configured to perform the processes in FIG. 4 and the foregoing method embodiments, and the lawful interception node is configured to perform the processes in FIG. 5 and the foregoing method embodiments, and a same technical effect can be achieved. To avoid repetition, details are not described herein again.

It should be noted that in this specification, the term “comprise”, “include”, or any of their variants is intended to cover a non-exclusive inclusion, so that a process, a method, an article, or an apparatus that includes a list of elements not only includes those elements but also includes other elements that are not expressly listed, or further includes elements inherent to such process, method, article, or apparatus. Without more constraints, an element preceded by “includes a . . . ” does not preclude the existence of additional identical elements in the process, method, article, or apparatus that includes the element. In addition, it should be noted that, the scope of the method and apparatus in the implementations of this application is not limited to performing functions in a sequence shown or discussed, and may further include performing functions in a basically simultaneous manner or in a reverse sequence based on the functions involved. For example, the described method may be performed in an order different from the order described, and various steps may be added, omitted, or combined. In addition, features described with reference to some examples may be combined in other examples.

According to the foregoing descriptions of the implementations, a person skilled in the art may clearly understand that the method in the foregoing embodiments may be implemented by software and a necessary general-purpose hardware platform, or certainly may be implemented by hardware. However, in many cases, the former is a better implementation. Based on such an understanding, the technical solutions of this application essentially or the part contributing to the related technologies can be embodied in a form of a computer software product. The computer software product is stored in a storage medium (such as a ROM/RAM, a magnetic disk, or an optical disc), and includes several instructions for enabling a terminal (which may be a mobile phone, a computer, a server, an air conditioner, a network device, or the like) to perform the method described in the embodiments of this application.

The embodiments of this application are described above with reference to the accompanying drawings. However, this application is not limited to the foregoing specific embodiments. The foregoing specific implementations are merely illustrative rather than restrictive. Inspired by this application, a person of ordinary skill in the art may develop many other manners without departing from principles of this application and the protection scope of the claims, and all such manners fall within the protection scope of this application.

What is claimed is:

1. An interception method, comprising:
obtaining, by a first node, interception information, wherein the interception information is used to indicate to intercept sensing of a target of interception; and
sending, by the first node, a sensing interception product of the target of interception to a lawful interception node based on the interception information.

2. The method according to claim 1, wherein the interception information comprises at least one of a target identifier or a service type, the target identifier is used to identify the target of interception, and the service type comprises at least one of sensing or a lawful access sensing service.

3. The method according to claim 2, wherein the target identifier comprises at least one of the following: a sensing target identifier, a sensing area identifier, an identifier of a sending node of a sensing request, or an identifier of a receiving node of a sensing result.

4. The method according to claim 3, wherein
in a case that a sensing target is a device that has a signal sending or receiving capability, the sensing target identifier comprises a device identifier; and
in a case that the sensing target is an object that does not have the signal sending or receiving capability, the sensing target identifier comprises at least one of geographic location information or time information.

5. The method according to claim 3, wherein the sensing area identifier comprises at least one of the following:
longitude, latitude, and altitude ranges;
an area identifier used by a mobile network;
a static reference point and first information, wherein the first information comprises at least one of a distance range, an angle range, or an altitude range; or
a dynamic reference point and second information, wherein the second information comprises at least one of a distance range, an angle range, or an altitude range.

6. The method according to claim 3, wherein
in a case that a target node is a device that is based on 3rd Generation Partnership Project 3GPP access, an identifier of the target node comprises a device identifier; and
in a case that the target node is an application server or an application function, the identifier of the target node comprises at least one of an internet protocol IP address, a media access control MAC address, or a port number; wherein
the target node comprises the sending node of the sensing request or the receiving node of the sensing result.

7. The method according to claim 2, wherein at least one of:
a network function that supports the lawful access sensing service preferentially processes a request of the lawful access sensing service; and
a privacy override indicator of the target of interception to be intercepted in the lawful access sensing service is set to “override”.

8. The method according to claim 2, wherein the interception information further comprises at least one of the following:
a type of intercept, wherein the type of intercept comprises at least one of sensing-related information or sensing content;
a service scoping, wherein the service scoping comprises sensing;
filtering criteria, wherein the filtering criteria comprise at least one of time information, geographic location information, or a sensing performance indicator; or
a sensing data category.

9. The method according to claim 8, wherein the sensing performance indicator comprises at least one of the following: sensing accuracy, sensing resolution, or sensing update frequency.

10. The method according to claim 1, wherein the sensing interception product comprises at least one of sensing-related information or sensing content.

11. The method according to claim 10, wherein the sensing interception product further comprises at least one of the following:
a timestamp, used to indicate time of obtaining the at least one of the sensing-related information or the sensing content; or
location information, used to indicate a location of the target of interception at the time of obtaining the at least one of the sensing-related information or the sensing content.

12. The method according to claim 10, wherein in a case that the first node is a network function node for network layer based interception, a sensing-related information event comprises at least one of the following:
exchanging sensing information, wherein the sensing information comprises at least one of a sensing request, a sensing response, a sensing configuration, a sensing report, or a sensing result that are related to the target of interception;
establishing, modifying, or releasing a communication channel used for lawful interception on sensing;
enabling interception on a first communication channel, wherein the first communication channel is any established communication channel used for lawful interception on sensing; or
stopping interception on a second communication channel, wherein the second communication channel is any established communication channel used for lawful interception on sensing.

13. The method according to claim 12, wherein the exchanging sensing information comprises at least one of the following:
the network function node exchanges, with an access network device, at least one of the sensing request, the sensing response, the sensing configuration, or the sensing report that are related to the target of interception;
the network function node exchanges, with a terminal, at least one of the sensing request, the sensing response, the sensing configuration, or the sensing report that are related to the target of interception; or
the network function node exchanges, with an application function, at least one of the sensing request, the sensing response, or the sensing result that are related to the target of interception.

14. The method according to claim 10, wherein in a case that the first node is a network function node for service layer based interception, a sensing-related information event comprises at least one of the following:
a sensing request for the target of interception;
a sensing response for the target of interception;
a sensing report for the target of interception; or
sensing quality of service QoS information of the target of interception.

15. The method according to claim 1, wherein in a case that the target identifier comprises a sensing area identifier, the method further comprises:
receiving, by the first node, first indication information, wherein
the first indication information is used to indicate at least one of the following:
a first sensing area is the same as a second sensing area, the first sensing area is a sensing area indicated by the sensing area identifier, and the second sensing area is a sensing area that a sensing request requests to sense;
the first sensing area comprises the second sensing area;
the second sensing area comprises the first sensing area; or
the first sensing area partially overlaps the second sensing area.

16. An interception method, comprising:
sending, by a lawful interception node, interception information, wherein the interception information is used to indicate to intercept sensing of a target of interception; and
receiving, by the lawful interception node, a sensing interception product of the target of interception from a first node.

17. The method according to claim 16, wherein the interception information comprises at least one of a target identifier or a service type, the target identifier is used to identify the target of interception, and the service type comprises at least one of sensing or a lawful access sensing service, and the method further comprises:
receiving, by the lawful interception node, an association relationship between a first identifier and the target identifier, wherein the first identifier comprises at least one of a temporary identifier of the target of interception or a network internal identifier, the first identifier is used when sensing data of the target of interception is exchanged between network function nodes through an interface, and the target identifier is used to identify at least one of a sensing target, a sensing area, a sending node of a sensing request, or a receiving node of a sensing result.

18. The method according to claim 17, wherein the association relationship between the first identifier and the target identifier is indicated by using an identifier event, and the identifier event comprises:
a subscription permanent identifier, wherein the subscription permanent identifier is the target identifier; and
an observed first identifier, wherein the observed first identifier is used when the sensing data of the target of interception is exchanged between the network function nodes through the interface.

19. A first node, comprising a processor and a memory, wherein the memory stores a program or instructions capable of being run on the processor, and the processor, upon executing the program or the instructions, is configured to:
obtain interception information, wherein the interception information is used to indicate to intercept sensing of a target of interception; and
sending a sensing interception product of the target of interception to a lawful interception node based on the interception information.

20. A lawful interception node, comprising a processor and a memory, wherein the memory stores a program or instructions capable of being run on the processor, and when the program or the instructions are executed by the processor, the interception method according to claim 17 are implemented.
